(19) United States
(12) Patent Application Publication
(10) Pub. No.: US 2009/0276832 A1
(43) Pub. Date: Nov. 5, 2009

(54) Controllable Information Diffusion Method

(76) Inventors: Pascal Belin, Villennes Sur Seine (FR); Sébastien Bertrand, Paris (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/085,264

(22) PCT Filed: Nov. 21, 2006
(86) PCT No.: PCT/FR2006/051202

§ 371 Date: May 19, 2008

(30) Foreign Application Priority Data
Nov. 21, 2005 (FR) 0553529

(51) Int. Cl. G06F 12/00; G06F 15/167; G06F 21/00

(52) U.S. Cl. 726/4; 709/216; 711/163

(57) ABSTRACT

A method of sending data via a communications network NTWK interconnecting terminals (T0 Tj TN). The method includes a step of storing information (Int0) at the command of the initiator terminal (T0) in a memory space S(Inf0) which is accessible to non-initiator terminals (T1, . . . , Tj, . . . , TN) only in read mode and a step of sending a non-initiator terminal a solicitation message Sm(1,P,A0,T1,T2) giving the location (A0) of said memory space S(Inf0). This method makes it possible to prevent the formation of loops perpetually circulating out-of-date requests.

The present invention relates to a method of transmitting data across a communications network that interconnects different terminals made available to different users.

Such methods are commonly used to enable personal computer users to communicate with one another via an Internet-type meshed network and, where applicable, one or more WiFi (Wireless Fidelity) wireless connections as defined in the IEEE 802.11 standard, for example. Such methods also enable mobile telephone users to communicate with one another, for example via a third generation UMTS (Universal Mobile Telecommunication System) mobile telephone network.

Such methods are used in electronic mail applications in particular.

The invention is linked to the following considerations: the inventors have found that, when an initiator terminal sends to one or more addressees a message carrying a request, the addressee(s) are entirely free to forward the message in question to other addressees, thus potentially giving rise to massive dissemination of the original request message, over which the initiator terminal very quickly loses control. This creates loops in which requests (which often become out of date) circulate perpetually, since such loops can be reactivated each time the request message is discovered by a new addressee, with the risk of that addressee forwarding the message to other addressees with no indication as to the history or context. Such loops are disagreeable for system users, firstly by bringing too many messages to their attention and secondly through causing unnecessary congestion of the communications network, which not only constitutes a waste in terms of bandwidth but also an operating cost and network maintenance overhead which in one way or another impacts on network users collectively, for example through impacting on the subscription costs invoiced to said users.

An aim of the present invention is to remove those drawbacks by proposing a data transmission method in which a request can be sent at the initiative of an initiator terminal without that initiator terminal losing control over subsequent dissemination of the request.

According to the invention, a method conforming to the introductory paragraph is characterized in that it includes:
a step executed at the command of one of the terminals, referred to as the initiator terminal, of storing information in a memory space to which only read mode access is possible for non-initiator terminals; and
a step of sending to a non-initiator terminal a solicitation message that includes a location indication indicating the location of said memory space.

Thus when the method of the invention is used, it is an invitation to consult information that is disseminated in the form of the solicitation message, where applicable without checking the initiator terminal, while the information itself, and in particular its validity period, can be closely controlled by the initiator terminal user. The location indication included in the solicitation message can take the form of a hypertext link or an address specific to the memory space in which the information in question is stored. A terminal that has received the solicitation message can request access to the information identified by that location indication, thus enabling its user to take note of the stored information.

The invention enables the initiator terminal user to eliminate the information identified by the location indication included in the solicitation message, for example if that information has become out of date, so that requests by subsequent addressees of such solicitation messages to access that information will fail, which will dissuade them from forwarding the solicitation message, which no longer has any purpose. Thus the invention prevents the formation of loops in which out-of-date requests circulate perpetually.

In a first variant of the invention, a solicitation message carries a response address to which any response to the solicitation message must be sent in order to be stored.

This variant of the invention authorizes centralized management of responses, all of which arrive at the same place in a system in which this variant of the method is used. In particular this enables the initiator terminal user to have exclusive control over the conditions under which each of these responses can be sent to terminals other than that which initially sent the response concerned. For example, this variant enables the initiator terminal user to act as a moderator by filtering responses they deem to be upsetting for themselves or for third parties.

In one particular embodiment of this first variant, the response address identifies a memory space to which only write-mode access is possible for a non-initiator terminal.

This particular embodiment in theory guarantees that no non-initiator terminal can access a response if no particular measure is implemented for authorizing such access.

In an advantageous embodiment of this first variant, a method as described above further includes a step of modifying access rights intended to be executed at the command of the initiator terminal and after which read-mode access to a memory space containing a response is authorized for a non-initiator terminal.

This embodiment is advantageous in that it provides a simple way for the user to exercise discretionary powers to select one or more users of non-initiator terminals to whom a response that they did not originally send might be made available. The possibility of communicating a response to third-party terminals in some circumstances makes it possible, for example, to advise the users of those third-party terminals that the request that is the subject of the original solicitation message has been satisfied, which will naturally dissuade said users from further propagating this solicitation message, which is by then out of date.

Execution of the access rights modification step can optionally be made subordinate to obtaining beforehand explicit authorization for this from the sender of the response in question.

Responses can be stored at separate locations in the memory space in which the information targeted in the original solicitation message is stored. However, it is usually preferable to group together all data relating to the same information, so that the response address that is carried by the solicitation message can be identical to the location indication that is also contained in the message. Under such circumstances, to prevent addressing conflicts that could result in loss of data, a method as described above further includes a step of seeking a free space adjacent the memory space identified by the location indication and a step of storing the response in said adjacent free space.

Accordingly, as explained above, the invention finds one particularly advantageous application in situations in which multiple successive transmissions of the same request are liable to occur, by enabling the initiator terminal user to retain some control over such dissemination of their request, which is particularly useful if its subject matter is of a personal nature, revealing details specific to the lifestyle of the initiator terminal user.

According to a second variant of the invention, which can be implemented instead of or in association with the first variant, a method as described above therefore further includes a step of forwarding from a given non-initiator terminal to another non-initiator terminal a solicitation message received by said given non-initiator terminal.

Such forwarding steps are advantageous in that they enable a solicitation message initially sent by a user of an initiator terminal who does not know an addressee to whom it would really be relevant to be progressively redirected in a natural way to the most relevant addressee by successive recipients of the solicitation message. After receiving a solicitation message, a given user naturally chooses as the next addressee a person who appears to that given user to be more capable than themselves of effectively processing the information to which the solicitation message relates.

According to one advantageous embodiment of this second variant, a method as described above is characterized in that it further includes a step of counting the number of times the same solicitation message has been sent and a step of comparing said number with a predetermined number.

This embodiment enables the initiator terminal user to exercise control over the dissemination of their solicitation message, in order to prevent excessive dissemination of the information to which that solicitation message relates. This embodiment limits redundant transmission of the same solicitation to the same addressee by different paths, and further prevents the formation of perpetual request circulation loops, especially for requests that are not yet out of date.

For example, each terminal can include means for incrementing a number conveyed by the solicitation message, with said means being activated at the actual time of transmission of the solicitation message by the terminal.

According to a third variant of the invention, which can be implemented instead of or in conjunction with the first and second variants, a method as described above further includes a step of assigning a relevance limit date to the solicitation message and a step of restricting access to the information targeted by the location indication included in said solicitation message, which restriction step is executed as soon as the relevance limit date has been passed.

This third variant prevents out-of-date information continuing to be the subject of a significant volume of calls by preventing transmission of that information subject to conditions defined by the initiator terminal user. This third variant therefore contributes to reducing the risk of forming loops perpetually circulating out-of-date requests.

The access restriction step can have different contents as a function of the circumstances in which the invention is used and apply increasingly more severe constraints to the information targeted by the location indication. At a first level of constraint, the access restriction step can only inhibit dissemination of solicitation messages, so that all terminal users who have already received a solicitation message can continue to consult the content of the memory space concerned and modify that content. At a second level of constraint, the access restriction step can prohibit all read mode access and write mode access to the information targeted by the location indication, so that this information is then purely and simply placed in archival storage for the exclusive benefit of the initiator terminal user. Finally, at a final level of constraint, the access restriction step can purely and simply eliminate the information targeted by the location indication.

In one particular embodiment of this third variant, a method as described above further includes a step of assigning a response limit date to the solicitation message and a step of inhibiting writing in a response memory space which is executed as soon as said response limit has been passed.

This particular embodiment defines another level of constraint between the first and second levels described above, enabling all terminal users who have already received a solicitation message to continue to consult the content of the memory space concerned, which is then fixed.

In some embodiments of this third variant of the invention, the initiator terminal user is preferably provided with means for dynamically defining the content of the access restriction step, enabling them to choose the level of constraint that appears to them to be the most relevant of the various levels of constraint described above.

One hardware aspect of the invention relates to a signal intended to be sent between two terminals belonging to a plurality of terminals interconnected by a communications network, which signal carries a solicitation message including a location indication of a memory space in which information has been stored at the command of a terminal called the initiator terminal, to which memory space only read-mode access is possible for non-initiator terminals.

Another hardware aspect of the invention relates to means for implementing the method described above in the form of a computer program intended to be executed in a data transmission system including a communications network adapted to interconnect different terminals, the computer program including:
a series of instructions adapted, at the command of a terminal called the initiator terminal, to cause execution of a step of storing information in a memory space to which only access in read mode is possible for non-initiator terminals; and
a series of instructions adapted to cause execution of a step of sending a non-initiator terminal a solicitation message which includes a location indication for said memory space.

A further hardware aspect of the invention relates to a memory medium in which a computer program as described above is stored.

A further hardware aspect of the invention relates to a data transmission system including a communications network adapted to interconnect different terminals, which system further includes:
storage means intended to be activated at the command of one of the terminals known as the initiator terminal and to store information in a memory space to which only read-mode access is possible for non-initiator terminals; and
means for sending a non-initiator terminal a solicitation message which includes a location indication of said memory space.

A further hardware aspect of the invention relates to a telecommunication device adapted to be connected to other telecommunication devices via a communications network and including means for sending a solicitation message to another telecommunication device, which solicitation message includes a location indication for a memory space in which at least one item of information is stored and to which only read-mode access is possible for said other telecommunication devices.

A further hardware aspect of the invention relates to a telecommunication device adapted to be connected to a plurality of telecommunication terminals via a communications network and including storage means adapted to be activated at the command of one of the terminals, referred to as the initiator terminal, and to store at least one item of information in a memory space to which only read-mode access is possible for non-initiator terminals.

Thus in some embodiments of the invention, the transmission means and the storage means can be in separate devices.

The invention can nevertheless be implemented by devices integrating solicitation message transmission means and means for storing information to which the requests relate, with the users of these terminals forming a community of persons characterized by the fact that each of its members has personal means available for implementing the invention.

The invention can be better understood in the light of the following description, which is given by way of non-limiting example and with reference to the appended drawings, in which:

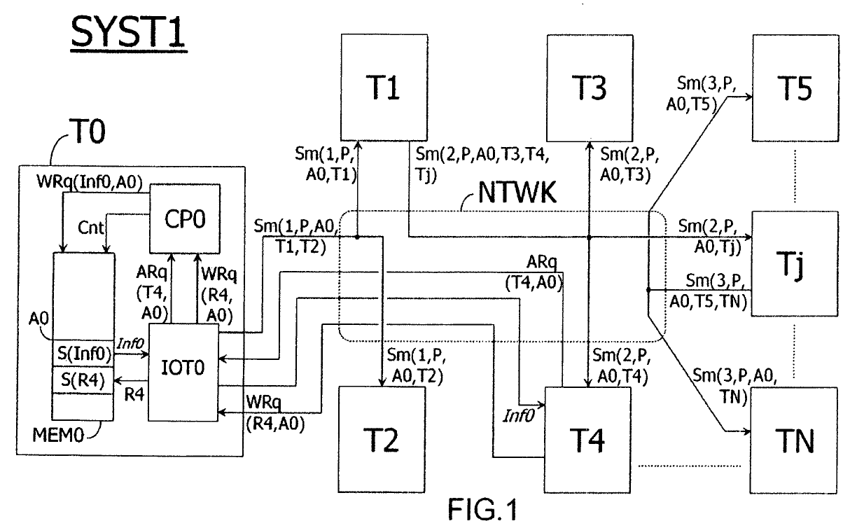

FIG. 1 is a functional block diagram of a first embodiment of a data transmission system in which a method of the invention is used;

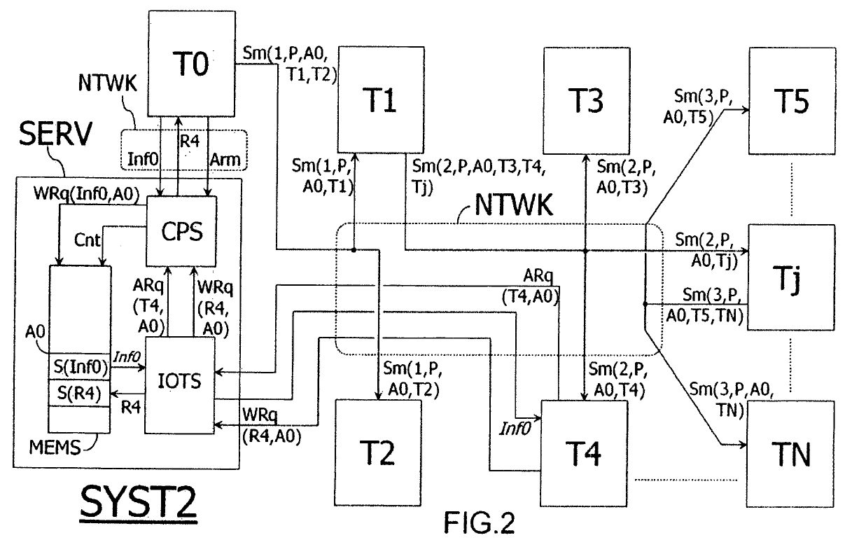

FIG. 2 is a functional block diagram of a second embodiment of a data transmission system of this kind.

FIG. 1 is a diagram showing a data transmission system SYST1 that conforms to a first embodiment of the invention and includes terminals T0, T1, T2, T3, T4, T5, . . . , Tj, . . . , TN interconnected by a communications network NTWK, for example an Internet-type meshed network that said terminals access via WiFi wireless connections or Ethernet, PSTN (public switched telephone network) or ADSL (asymmetric digital subscriber line) connections.

In the present embodiment of the invention, the terminal T0 sends other terminals a request defined by its user and the terminal T0 is therefore an initiator terminal. The request can merely communicate information or take the form of an enquiry, and can where appropriate include an attachment such as an audiovisual programme. Thus if the user of the terminal TO has a vacant room in their apartment, they can formulate a request in the form of a set Inf0 of information including an offer to rent said vacant room and an audio/video recording of a tour of the apartment with a commentary.

To this end, the initiator terminal T0 includes storage means MEM0 activated in this example by a write command signal WRq(Inf0,A0) emanating from a central processor unit CP0 included in the terminal T0. These storage means therefore store the set Inf0 of information in a memory space S(Inf0) delimited by an initial address A0, to which memory space S(Inf0) access is available only in read mode for the non-initiator terminals T1, T2, T3, T4, T5, . . . , Tj, . . . , TN, i.e. all the terminals other than the initiator terminal T0.

The initiator terminal T0 further includes means included in an input/output interface IOT0 for sending a solicitation message Sm(1,P,A0,T1,T2), addressed in this example to the terminals T1 and T2. This solicitation message Sm(1,P,A0,T1,T2) includes a location indication for the memory space S(Inf0) in which the set Inf0 of information is stored. This location indication is then formed by the initial address A0.

The solicitation message Sm(1,P,A0,T1,T2) further includes a first field including a number corresponding to the number of times that the message has been sent, which number has a value equal to 1 at this stage of the execution of the method of the invention. The solicitation message Sm(1,P,A0,T1,T2) includes a second field including a number P corresponding to a maximum number of successive transmissions of the solicitation message, which number is predefined by the user of the initiator terminal T0 and inserted into the message Sm(1,P,A0,T1,T2) by the central processor unit CP0. Thus when a non-initiator terminal receives this kind of solicitation message, it compares the numbers contained in the first and second fields described above with each other and deduces whether or not it is authorized to forward the solicitation message concerned to other terminals, such comparison resulting, for example, in inhibiting the transmission means in the non-initiator terminal concerned.

In this example, the solicitation message Sm(1,P,A0,T1,T2) is divided by the communications network NTWK into two individual messages SM(1,P,A0,T1) and Sm(1,P,A0,T2) for the non-initiator terminals T1 and T2, respectively. Each user of one of these terminals can then consult the set Inf0 of information with a view to taking note of the request that was initially sent specifically to them by the user of the initiator terminal T0. The figure does not show this exchange of signals, but a similar exchange is described below.

With the present assumption as to how the system works, the user of the non-initiator terminal T1, after consulting the set Inf0 of information, considers that users of other non-initiator terminals T3, T4, and Tj could be relevant addressees of the request represented by that set Inf0 of information. The user of the non-initiator terminal T1 then forwards a solicitation message Sm(2,P,A0,T3,T4,Tj) in which the first field includes a number equal to 2, which is possible only if P is greater than or equal to 2. This solicitation message Sm(2,P,A0,T3,T4,Tj) can include an additional commentary inserted by the user of the terminal T1 for the attention of the users of the terminals T3, T4, and Tj. The solicitation message Sm(2,P,A0,T3,T4,Tj) is then divided by the communications network NTWK into three messages SM(2,P,A0,T3), SM(2,P,A0,T4) and SM(2,P,A0,Tj) for the non-initiator terminals T3, T4, and Tj, respectively. Each user of one of these terminals can then consult the set Inf0 of information with a view to taking note of the request, even though it was not sent to them directly by the user of the initiator terminal T0.

With the present assumption as to how the system functions, the user of the non-initiator terminal Tj, after consulting the set Inf0 of information, considers that users of other non-initiator terminals T5 and TN could be relevant addressees of the request represented by that set Inf0 of information. The user of the non-initiator terminal Tj then forwards a solicitation message Sm(3,P,A0,T5,TN) in which the first field includes a number equal to 3, which is possible only if P is greater than or equal to 3. This solicitation message Sm(3,P,A0,T5,TN) is then divided into two messages Sm(3,P,A0,T5) and Sm(3,P,A0,TN) for the non-initiator terminals T5 and TN, respectively, and the users thereof can then consult the set Inf0 of information.

This figure shows how the terminal T4 accesses the set Inf0 of information: to this end, said terminal T4 sends the initiator terminal T0 a request ARq(T4,A0) to access the information designated by the address A0, said request also carrying an identifier of the terminal T4 from which it emanates. This request is received by the initiator terminal T0 via the input/output interface IOT0 and forwarded to the central processor unit CP0 for authorization. After the central processor unit CP0 has identified the sender of the access request ARq(T4,A0) as authorized to take note of the information Inf0, it sends the storage means MEM0 a command signal Cnt instructing them to grant the terminal T4 read-mode access to said information Inf0 via the input/output interface IOT0.

Thus, according to the invention, the set Inf0 of information that the terminal T4 requesting it accesses cannot be stored at the command of the user of said terminal, the set Inf0 of information being intrinsically configured in “read-only” mode, for example, which is symbolized graphically by the fact that the reference Inf0 allocated to the return signal incoming to the terminal T4 is shown in italics. The invention therefore enables the user of the initiator terminal T0 to eliminate all access to the set Inf0 of information, for example if that information has become out of date, and thus prevent transmission of that information Inf0 within the system SYST1, so that any request by any subsequent recipient of a solicitation message concerning it to access that information Inf0 will fail, which will dissuade them from forwarding the solicitation message, which has become useless. A relevance limit state can optionally be inserted into a field of the solicitation message, not shown in the figure, access to the information targeted by the location indication included in said solicitation message then being restricted as soon as the relevant limit date has passed, in order to prevent out-of-date information continuing to be the subject of a significant volume of calls by preventing transmission of that information subject to conditions defined by the user of the initiator terminal T0.

The access restriction step can just inhibit dissemination of solicitation messages but could equally prohibit all read-mode and write-mode access to the information targeted by the location indication or, at an ultimate level of constraint, purely and simply eliminate the information targeted by the location indication.

The solicitation message can further be assigned a response limit date, means for inhibiting writing a response in a memory space being activated as soon as said response limit date has passed. These writing inhibiting means can be integrated into each terminal to inhibit the transmission means of the terminal, which is then provided with an internal clock synchronized to a clock included in the initiator terminal, which clocks are not shown here. These means for inhibiting writing could also be integrated into the initiator terminal itself and operate directly on the storage means MEM0. With the assumption illustrated here, after consulting the information Inf0, the user of the non-initiator terminal T4 considering that a response on their part would be beneficial, sends a response message which, in this particular embodiment of the invention, takes the form of a request WRq(R4,A0) to write said response R4. This write request is received via the input/output interface IOT0 by the central processor unit CP0 included in the initiator terminal T0 and designates, as the required writing address, the response address identical to the location indication formed by the initial address A0, which here is the result of a convention as to the operation of all terminals whereby the fields including the response address and the location indication are merged.

In other embodiments of the invention two separate fields are used in the solicitation message to indicate, firstly, the location of the information to which said message relates and, secondly, a response address different from that location indication, which response address can furthermore be that of storage means other than those containing the information to which the solicitation message relates, and which other storage means can even be located remotely of the initiator terminal and where appropriate connected to it via the communications network.

Here the initiator terminal T0 is provided with means for seeking a free space S(R4) adjacent the memory space S(Info0) identified by the location indication A0, in order to write the response R4 therein, which means are included here in the central processor unit CP0 and group together all data relating to the same information using a single address predefined in the solicitation message and without causing addressing conflicts that could result in loss of data. After identifying an initial address of this adjacent free space S(R4), the central processor unit CP0 instructs the storage means MEM0 to store the response R4 therein, with a view to making it possible for the user of the initiator terminal T0, and only that user, to consult it, this free space S(R4) having been configured beforehand by the central processor unit CP0 to be accessible in write mode only. After taking note of the content of the response R4, the initiator terminal user can instruct the central processor unit CP0 by means of an appropriate command signal Cnt to modify the access rights attached to the memory space containing said response R4, for example to make it accessible in read mode to the other non-initiator terminals T1, T2, T3, . . . , Tj, . . ., TN. In embodiments other than that described here, an exchange of signals could be effected beforehand between the initiator terminal T0 and the terminal T4 in order to collect an explicit disclosure authorization from the latter in their response R4 to other users.

This embodiment is advantageous in that it provides the user with a simple way to exercise a discretionary power to select one or more non-initiator terminal users to whom a response that they did not initially send can be made available. The possibility of communicating a response to third-party terminals in some circumstances makes it possible for the users of these third-party terminals to take note that the request that is the subject of the original solicitation method has been satisfied, for example, which will naturally dissuade said users from propagating any farther a solicitation message that has become out of date.

On an entirely different assumption, the user of the initiator terminal T0 may judge the content of the response R4 to be unsuitable or upsetting, in which case they can act as a moderator purely and simply by eliminating the response or even by instructing the central processor unit CP0 to reject in future any write request emanating from the terminal T4 that sent the response R4.

The steps of storage, sending the solicitation message, storing responses to that message, and modifying access rights to such responses are advantageously defined by one or more series of instructions that can be executed by the central processor unit CP0 and stored beforehand either in the storage means MEM0 or on a memory medium, not shown here, separate from the storage means MEM0 but accessible to the central processor unit CP0, for example an add-on hard disk, an optical or magneto-optical storage disk, or a portable memory device of the smart card, memory stick or USB (Universal Serial Bus) key type.

FIG. 2 is a diagram representing a data transmission system SYST2 that conforms to a second embodiment of the invention and includes, in addition to terminals T0, T1, T2, T3, T4, T5, . . . , TJ, . . . , TN interconnected by a communications network NTWK, an intermediary communication device here taking the form of a server SERV that is controlled at least partially by an initiator terminal, which is the terminal T0 in this example. As far as possible, elements common to this figure and the previous figure are assigned the same reference symbols.

Here the server SERV includes storage means MEMS, a central processor unit CPS, and an input/output interface IOTS respectively similar to the storage means MEM0, the central processor unit CP0, and the input/output interface IOT0 described above, except that the central processor unit CPS is controlled by the initiator terminal T0, which in the present example sends the message Sm(1,P,A0,T1,T2) itself, while the address A0, to which any response to a solicitation message of this kind must be sent, designates a memory space S(Info0) now located in the server SERV and not in the initiator terminal T0, the above description of the operations of propagating solicitation messages, consulting information to which those messages relate, and sending responses to those messages being transposable to this second embodiment of the invention.

In other embodiments of the invention, the solicitation message sending means can equally be integrated into the server SERV, the initiator terminal T0 then no longer having any direct contact other than with the server SERV.

The initiator terminal T0 and the server SERV exchange a signal carrying information Inf0 to be stored in the storage means MEMS, a signal carrying the response R4 to be transmitted to the user of the initiator terminal T0, and a signal Arm carrying an instruction for modifying the rights of access to that MEMS response that is stored in the storage means MEMS. In a situation in which the initiator terminal T0 and the server SERV are not located in the same geographical place, the signals referred to above are advantageously transmitted via the communications network NTWK, an extension of which between the initiator terminal T0 and the server SERV is shown in this figure. Moreover, since the initiator terminal and the server can in theory be physically separate, it is entirely feasible to assign each terminal included in the system SYST2 the facility to assume control of a portion of the storage means MEMS via the central processor unit CPS, in order to enable each of these terminals to become an initiator terminal in order to fulfill a function similar to that devolved upon the terminal T0 in the operating assumption illustrated here.

1. A method of sending data over a communications network adapted to interconnect different terminals, the method including:
a step executed at the command of one of the terminals, referred to as the initiator terminal, of storing information in a memory space to which only read mode access is possible for non-initiator terminals; and
a step of sending to a non-initiator terminal a solicitation message that includes a location indication indicating the location of said memory space.

2. The method according to claim 1, wherein a solicitation message carries a response address to which any response to the solicitation message must be sent in order to be stored.

3. The method according to claim 2, wherein the response address identifies a memory space to which only write-mode access is possible for a non-initiator terminal.

4. The method according to claim 3, further comprising a step of modifying access rights intended to be executed at the command of the initiator terminal and after which read-mode access to a memory space containing a response is authorized for a non-initiator terminal.

5. The method according to claim 2, wherein, the response address being identical to the location indication, said method further includes a step of seeking a free space adjacent the memory space identified by the location indication and a step of storing the response in said adjacent free space.

6. The method according to claim 1, further comprising a step of forwarding from a given non-initiator terminal to another non-initiator terminal a solicitation message received by said given non-initiator terminal.

7. The method according to claim 6, further comprising a step of counting the number of times the same solicitation message has been sent and a step of comparing said number with a predetermined number.

8. The method according claim 1, further comprising a step of assigning a relevance limit date to the solicitation message and a step of restricting access to the information targeted by the location indication included in said solicitation message, which restriction step is executed as soon as the relevance limit date has been passed.

9. The method according to claim 1, comprising a step of assigning a response limit date to the solicitation message and a step of inhibiting writing in a response memory space which is executed as soon as said response limit has been passed.

10. A signal intended to be sent between two terminals belonging to a plurality of terminals interconnected by a communications network, which signal carries a solicitation message including a location indication of a memory space in which information has been stored at the command of a terminal called the initiator terminal, to which memory space only read-mode access is possible for non-initiator terminals.

11. A computer program intended to be executed in a data transmission system including a communications network adapted to interconnect different terminals, the computer program including:
a series of instructions adapted, at the command of a terminal called the initiator terminal, to cause execution of a step of storing information in a memory space to which only access in read mode is possible for non-initiator terminals; and
a series of instructions adapted to cause execution of a step of sending a non-initiator terminal a solicitation message which includes a location indication for said memory space.

12. A memory medium in which a computer program according to claim 11 is stored.

13. A data transmission system including a communications network adapted to interconnect different terminals, which system further includes:
storage means intended to be activated at the command of one of the terminals known as the initiator terminal and to store information in a memory space to which only read-mode access is possible for non-initiator terminals; and
means for sending a non-initiator terminal a solicitation message which includes a location indication for said memory space.

14. A telecommunication device adapted to be connected to other telecommunication devices via a communications network and including means for sending a solicitation message to another telecommunication device, which solicitation message includes a location indication for a memory space in which at least one item of information is stored and to which only read-mode access is possible for said other telecommunication devices.

15. A telecommunication device adapted to be connected to a plurality of telecommunication terminals via a communications network and including storage means adapted to be activated at the command of one of the terminals, referred to as the initiator terminal, and to store information in a memory space to which only read-mode access is possible for non-initiator terminals.
